(19) United States
(12) Patent Application Publication
(10) Pub. No.: US 2017/0088191 A1
(43) Pub. Date: Mar. 30, 2017

(54) SERVICE PLATFORMS FOR TUB RAILS OF UTILITY VEHICLES

(71) Applicant: Benjamin Grunow, Darien, CT (US)

(72) Inventor: Benjamin Grunow, Darien, CT (US)

(21) Appl. No.: 14/868,438

(22) Filed: Sep. 29, 2015

(51) Int. Cl. B62D 33/02; B63B 17/04

(52) U.S. Cl. CPC B62D 33/0207; B63B 17/04

(57) ABSTRACT

A service platform for a utility vehicle tub rail, comprising a planar platform element wider than the utility vehicle tub rail, and fastening apparatus for connecting the planar platform element to the utility vehicle tub rail. A service platform may further comprise at least one specialty fitting mounted to the planar platform element. Preferably, a service platform is modified in form for at least one specialty function, wherein the form is selected from the group consisting of slots, drink glass socket, chock, and combinations thereof. Preferably, a service platform is shaped to fit a specific tub rail for a specific vehicle.

### BACKGROUND OF THE INVENTION

The present invention is directed to accessories for vehicles; more particularly, to accessories for application to upper support surfaces of vehicles; and most particularly to service platforms for application to the upper surfaces of tub sides of utility vehicles such as certain Jeep® brand vehicles (e.g., CJ, Willys, VJ, FJ, YJ and TJ series models), all-terrain and utility vehicles such as pickup trucks and service ATVs, and boats.

In the prior art, the upper surfaces of tub sides are generally referred to as “tub rails”. Typically, tub rails are provided by a vehicle manufacturer finished in the paint color of the vehicle and thus are vulnerable to damage. Because a utility vehicle may undergo relatively severe usage during the working lifetime of the vehicle, it is known to provide protective tub rail “body armor”, e.g., Rugged Ridge Black Tub Rail Body Armor for Jeep-type vehicles, available through Amazon.com. The tub rail body armor is narrower than the width of the supportive tub rail, is formed of relatively thin molded plastic, and is attached to the vehicle only by double-sided tape; hence, the tub rail body armor is intended only to protect the tub rail surface from damage and is not suited to heavy duty use as a utility vehicle service platform for sitting, standing, climbing, supporting of cargo, or providing or securing mounting of attachment means for ropes, straps, and other fasteners in accordance with the present invention.

### SUMMARY OF THE INVENTION

In accordance with the present invention, a service platform for a utility vehicle tub rail comprises a planar element having a preferred length substantially equal to the length of a tub rail and having a preferred width substantially wider than the width of the tub rail and having a preferred thickness of about one inch. Preferably, a service platform is attachable to a tub rail through the use of holes provided in the tub rail by the manufacturer, thus obviating the need to drill new holes. A service platform preferably comprises threaded or spring-loaded fasteners for engaging the tub rail holes. Preferably, such fasteners are either hidden from or flush with the upper surface of the service platform. Further, a service platform may be provided with openings, cutouts, cleats, hooks, screw eyes, and the like for the securing of fastening means (e.g., ropes, wires, cables, straps, etc.), to assist in securing and carrying cargo safely in a tub rail vehicle.

Further features and advantages of the present invention will become apparent to those of ordinary skill in the art in view of the drawings and detailed description of preferred embodiments below.

### BRIEF DESCRIPTION OF THE DRAWINGS

The present invention will now be described, by way of example, with reference to the accompanying drawings, in which:

FIG. 1 is an isometric view from above of a portion of a utility vehicle tub equipped with left- and right-side service platforms in accordance with the present invention;

FIG. 2 is a cross-sectional view of a service platform mounted on a Jeep-type vehicle tub rail in accordance with the present invention;

FIG. 3 is a cross-sectional view of a first embodiment of a service platform mounted on a pickup-type vehicle tub rail in accordance with the present invention;

FIG. 4 is a cross-sectional view of a second embodiment of a service platform mounted on a pickup-type vehicle tub rail in accordance with the present invention;

FIG. 5 is a cross-sectional view of a service platform comprising an eye-bolt for attaching fastening means for securing cargo;

FIG. 6 is a cross-sectional view of a service platform comprising a blind attachment to a vehicle tub rail;

FIG. 7 is a cross-sectional view of a service platform comprising a socket for holding a drink container;

FIG. 8 is an isometric view from above of a first embodiment of a service platform in accordance with the present invention, exemplarily configured for use on the left-side tub rail of a 2007-2015 Jeep Wrangler having an open tub; and

FIG. 9 is an isometric view from above of a second embodiment of a service platform in accordance with the present invention, exemplarily configured for use on the left-side tub rail of a 2007-2015 Jeep Wrangler having a removable top.

### DETAILED DESCRIPTION OF THE PREFERRED EMBODIMENT

Referring now to FIG. 1, a utility vehicle tub 10 is equipped with left- and right-side service platforms 12, 14 mounted to the left- and right-side tub rails, respectively, in accordance with the present invention. A vehicle tub is defined herein as an open area having a floor 16, opposing left and right partial sides 18, 20, and a rear side 22 that typically is a tail gate. The tub rails are defined as the upper surfaces 24, 26 of partial sides 18, 20, respectively.

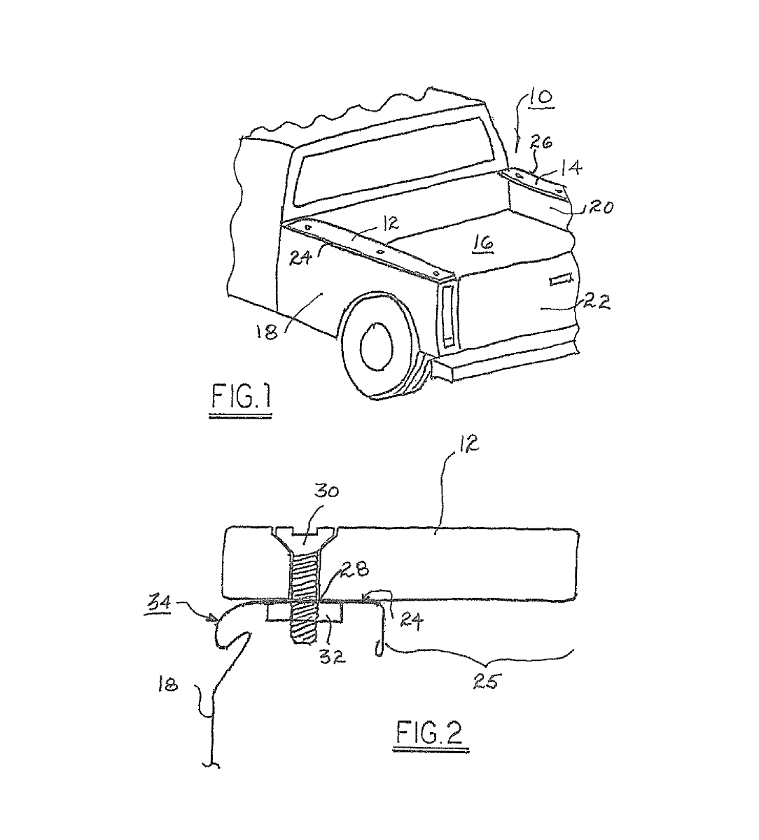

Referring now to FIG. 2, a first exemplary embodiment 12 of a service platform in accordance with the present invention is shown being mounted to the left side 18 and left tub rail 24 of a Jeep-type vehicle (not shown). Tub rail 24 includes at least one hole 28 formed therein, preferably by the vehicle manufacturer. (In the unlikely event that a vehicle does not have a manufactured hole through its tub rail, it may become necessary to drill such a hole for platform attachment.) Hole 28 is used for flush mounting service platform 12 to tub rail 24 via a cone-headed machine screw 30 and nut 32, screw 30 being countersunk into the upper surfaces of service platforms 12 and 14.

Service platforms in accordance with the present invention are provided typically as enantiomorphic pairs for left and right tub rails of a vehicle, although non-matching pairs are within the scope of the present invention where required either to conform to non-matching sides of a vehicle or to provide some particular feature on one side but not the other side.

At least one service platform 12 or 14 is preferably cantilevered a substantial distance into vehicle tub 10 from tub rail 24, allowing various accessories and alterations as described below, and further allowing comfortable seating or standing thereon.

Service platforms in accordance with the present invention may be formed of any convenient, rigid and sturdy material, such as but not limited to wood lumber, laminated wood, metal such as steel or aluminum, polymer, glass-filled polymer, fiberglass, and combinations thereof. Such platforms may be formed by any conventional forming process, such as but not limited to, sawing, milling, drilling, molding, injection molding, three-dimensional printing, and combinations thereof.

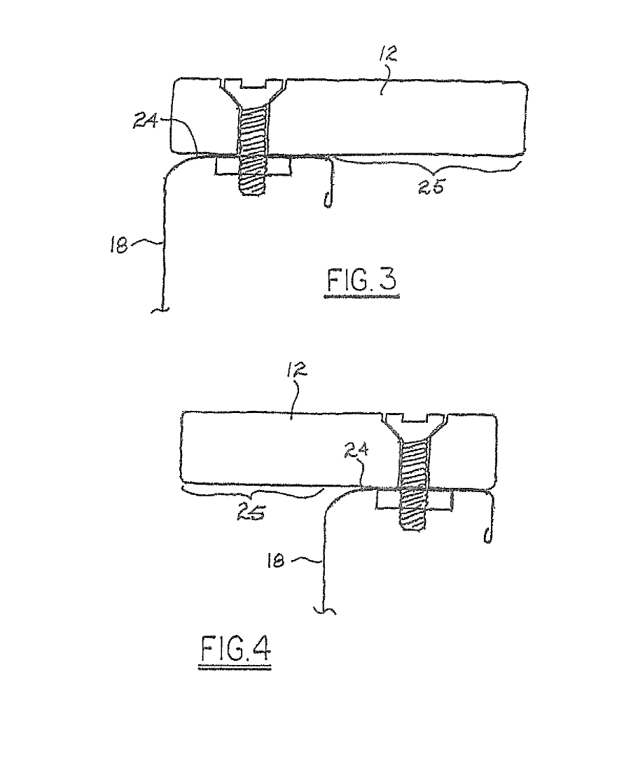

In a preferred embodiment of the invention, platforms 12 and 14 may be made from the milling of wood, the final thickness of which depends on the type of wood selected and the anticipated use of the platforms and may vary as a result thereof. Currently preferred width of service platform 12a is between about 3 inches and about 8 inches, preferably about 6 inches. When disposed on a Jeep-style tub rail, service platform 12 is constrained in outboard width as shown in FIG. 2 and may not overhang tub side 18 because rolled feature 34 must remain available for engaging the vehicle top (not shown). When such access is not required, and the vehicle side merges into the tub rail as typically occurs in an open-tub pickup truck, as shown in FIGS. 3 and 4, a service rail 12 may extend 25 inboard (FIG. 3), outboard (FIG. 4), or both inboard and outboard of the tub rail 24.

Referring now to FIG. 5, service platform 12 may be attached to tub rail 24 by any of various connectors, e.g., a through-bolt, an eye-bolt 40 that serves both to secure service platform 12 to tub rail 24 and provide a convenient attachment for lashings such as ropes, cables, wires, straps, and the like for securing cargo in tub 10. Of course, service platform 12 may be attached by a simple machine bolt or carriage bolt. Any of various specialty fittings such as a screw-eye, screw hook, snap shackle, or mooring cleat (not shown) may be screwed into either the upper surface or the lower surface of a service platform 12 at any point, as may any type of threaded fastener.

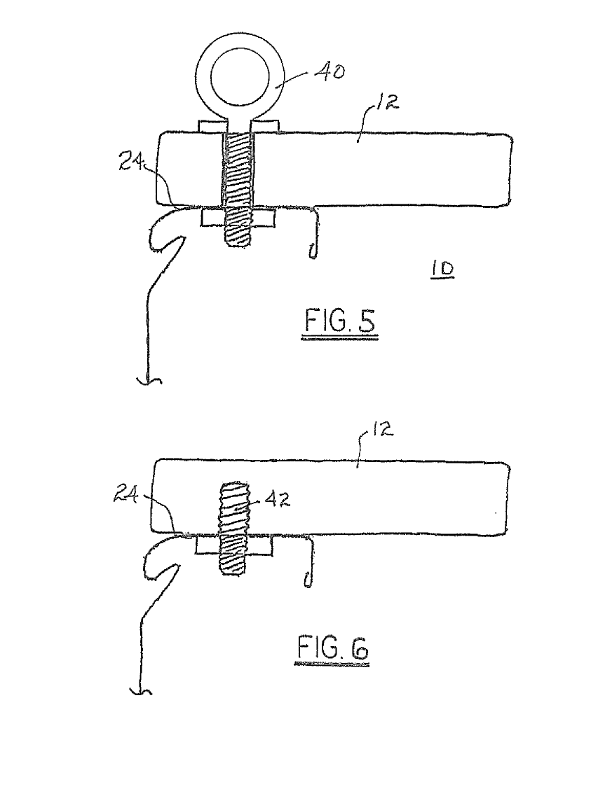

Referring now to FIG. 6, service platform 12 may be attached to tub rail 24 via any of various types of blind fasteners as may be desired, e.g., screw bolt 42 or hitch pin assembly (not shown).

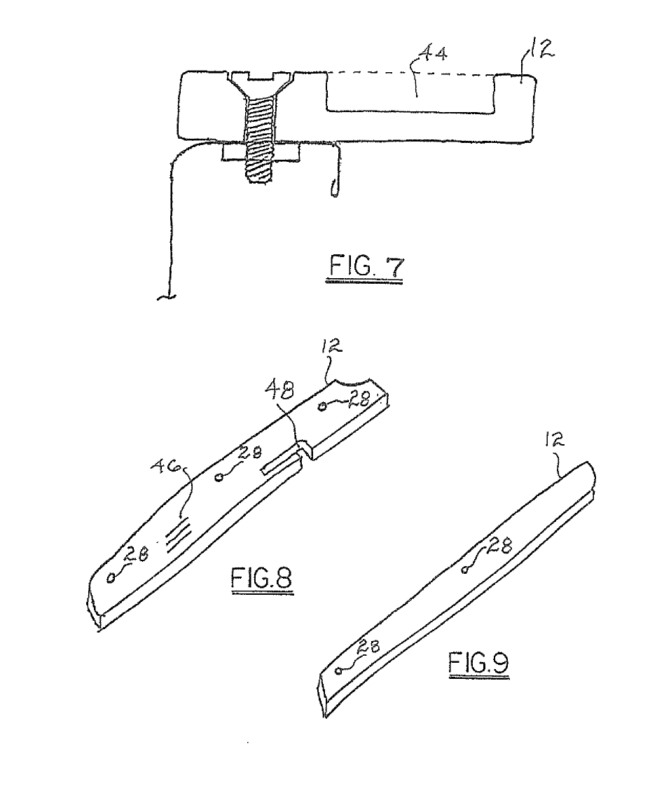

Referring now to FIGS. 7 through 9, service platform 12 may be modified in any of various forms as may be desired, e.g., a socket 44 for receiving a drinking glass; slots 46 (which depicted for example only and may have various shapes and sizes to support general and specific applications and uses); or chock 48. Further, service platform may be shaped on the sides and/or ends to match the contours of specific vehicles, e.g., left tub rail of a 2007-2015 Jeep Wrangler with an open tub (FIG. 8), or left tub rail of a 2007-2015 Jeep Wrangler with a soft top (FIG. 9).

Various changes may be made to the structure embodying the principles of the invention. The foregoing embodiments are set forth in an illustrative and not in a limiting sense. The scope of the invention is defined by the claims appended hereto.

What is claimed is:

1. A service platform for a utility vehicle tub rail, comprising:
a) a planar platform element attachable to a top surface of said utility vehicle tub rail such that after installation on said utility vehicle tub rail said service platform resides exclusively on said top surface; and
b) fastening apparatus for connecting said planar platform element to said top surface of said utility vehicle tub rail.

2. A service platform in accordance with claim 1 wherein said planar platform element is wider than said utility vehicle tub rail.

3. A service platform in accordance with claim 1 modified in form for at least one specialty function.

4. A service platform in accordance with claim 3 wherein said form is selected from the group consisting of slots, drink glass socket, chock, and combinations thereof.

5. A service platform in accordance with claim 1 wherein said planar platform element is shaped to fit a specific tub rail for a specific vehicle.

6. A service platform in accordance with claim 1 wherein said fastening apparatus is fixedly attached to said planar platform element.

7. A service platform in accordance with claim 1 wherein said fastening apparatus is selected from the group consisting of through-fasteners and blind fasteners.

8. A service platform in accordance with claim 1 wherein said planar platform element is provided with at least one through-hole that aligns with at least one hole provided by a vehicle manufacturer in said top surface of said tub rail.

9. A service platform in accordance with claim 1 wherein said service platform is a first service platform for attachment to a first side of a vehicle, further comprising a second service platform for attachment to a second side of said vehicle.

10. A service platform in accordance with claim 9 wherein said first and second service platforms are enantiomorphs.

11. A service platform in accordance with claim 1 further comprising a specialty fitting selected from the group consisting of screw eye, screw hook, snap shackle, and mooring cleat.

12. A service platform in accordance with claim 1 wherein said service platform is formed of a material selected from the group consisting of wood lumber, laminated wood, metal, polymer, glass-filled polymer, fiberglass, and combinations thereof.

13. A service platform in accordance with claim 1 wherein said service platform is formed by a process selected from the group consisting of sawing, drilling, milling, molding, injection molding, three-dimensional printing, and combinations thereof.

14. A service platform in accordance with claim 1 wherein said utility vehicle is selected from the group consisting of Jeep® brand vehicles, all-terrain vehicles, pickup trucks, service ATVs, and boats.
